(19) United States
(12) Patent Application Publication
(10) Pub. No.: US 2004/0218771 A1
(43) Pub. Date: Nov. 4, 2004

(54) Method for production of an approximated partial transfer function

(75) Inventors: Josef Chalupper, Paunzhausen (DE); Uwe Rass, Numberg (DE)

Correspondence Address: SCHIFF HARDIN, LLP, PATENT DEPARTMENT, 6600 SEARS TOWER, CHICAGO, IL, 60606-6473, US

(73) Assignee: Siemens Audiologische Technik GmbH

(21) Appl. No.: 10/827,764

(22) Filed: Apr. 20, 2004

(30) Foreign Application Priority Data
Apr. 22, 2003 (DE) 103 18 191.1

(51) Int. Cl. H04R 25/00; H04B 15/00

(52) U.S. Cl. 381/320; 381/316; 381/94.2

(57) ABSTRACT

A method for producing an approximated partial transfer function can be used in an electroacoustic appliance for producing an environment correction transfer function that matches an appliance transfer function for the electroacoustic appliance to an acoustic environment, by a) providing a number of basic functions, which each have one basic characteristic of a spectral profile of partial transfer functions, b) providing the approximated partial transfer function by combination of the basic functions weighted by weighting factors, in that at the weighting factor is in each case determined for each basic function such that operation of the electroacoustic appliance is matched to an acoustic environment taking into account the approximated partial transfer function which is formed by the weighting factors and the basic functions, and c) storing the approximated partial transfer function in the electroacoustic appliance for use during operation.

### BACKGROUND OF THE INVENTION

The invention relates to a method for production of an approximated partial transfer function, which can be used in an electroacoustic appliance for production of an environment correction transfer function, which matches an appliance transfer function for the electroacoustic appliance to an acoustic environment.

In general, a transfer function that describes the transmission of an acoustic signal from one location to another location can be associated with any sound propagation. As soon as an electroacoustic appliance is part of the sound propagation—for example, a hearing aid which is intended to compensate for a hearing weakness—this affects the sound propagation. The electroacoustic appliance is preferably arranged such that it has as little influence as possible on the acoustic environment and on the sound propagation.

A hearing aid that is worn in the ear, for example, significantly influences only the sound propagation in the auditory channel in which it is accommodated, but has scarcely any effect on the method of operation of the auricula. A hearing aid which is worn behind the ear (“behind-the-ear hearing aid”) passes around the auricula, so that the spectral coloring by the outer ears does not take place. This results, for example, in important direction and elevation information being lost, which results in the known localization problems (for example, confusion between front and rear) of those with hearing impediments who wear behind-the-ear hearing aids. The disturbance with the three-dimensional acoustic orientation associated with this, and thus the tonal quality overall, frequently contribute to rejection of the hearing aid. For these reasons, the acoustic influence of the ear and of the head, that is to say, of the acoustic environment, should ideally be taken into account in the hearing aid.

Without a hearing aid, a “natural transfer function” describes the undisturbed transmission of sound from a sound source to the tympanic membrane. With a hearing aid, which is used here as being representative of an electroacoustic appliance, the transfer function is composed of a modified transfer function from the sound source to a microphone of the electroacoustic appliance, and of the appliance transfer function itself. The modified transfer function is referred to in the following text as the “partial transfer function” since, to a certain extent, it represents a part of the natural transfer function, with the aim being to compensate for the difference in the acoustic appliance once again in order to produce natural hearing.

The appliance transfer function itself is composed of an appliance-specific transfer function which, for example, is matched to a correction for the hearing weakness, and of an environment correction transfer function which as far as possible minimizes the difference between the transfer function using the electroacoustic appliance for the natural transfer function and thus as far as possible prevents information loss for the ear when using the electroacoustic appliance. The appliance-specific transfer function includes the transfer function from the hearing aid loudspeaker to the tympanic membrane. The environment correction transfer function is ideally produced with the aid of the partial transfer function which, however, is different for every acoustic environment, for example, for each hearing aid wearer, and must therefore be predetermined in each case.

In the field of hearing aid acoustics, “head-related transfer functions”(HRTFs) describe the transmission of sound from a sound source to a tympanic membrane in an ear (natural head-related HRTF) or to a microphone of a hearing aid (modified head-related HRTF, or HRTF′). An HRTF/HRTF′ is a Fourier Transform of an impulse response between a source (noise) which is emitting a broad frequency range and, for example, a tympanic membrane, and this is also referred to as the HRIR (Head Related Impulse Response). The impulse response can be used to determine the sound pressure which any given sound source produces in front of the tympanic membrane of a person.

The HRTF/HRTF′ includes all the physical characteristic variables for localization of a signal source. If the HRTFs/HRTF′s for the left and right ears are known, binaural signals from an acoustic source can also be synthesized.

Transfer functions are very sensitive to changes in the acoustic environment, for example, to the shape of an auricular, to the position of a microphone on the head, and to a change in the incidence direction from which sound arrives at the electroacoustic appliance. The HRTFs/HRTF′s of different persons also differ in a corresponding manner.

In an environment without any reverberation, an HRTF/HRTF′ is a function of four variables: the three spatial coordinates (related to the head) and the frequency. In order to determine the HRTFs/HRTF′s, the measurements are generally carried out on a synthetic head, for example, the KEMAR (Knowles Electronics Mannequin for Acoustical Research). An overview of the determination of HRTFs is known, for example, from Yang, Wonyoung, “Overview of the Head-Related Transfer Functions (HRTFs)”, ACS 498B Audio Engineering, The Pennsylvania State University, July 2001.

The knowledge of the respectively relevant partial transfer functions when using electroacoustic appliances is a critical factor for improvement of algorithms whose method of operation depends on the acoustic environment, for example on the sound incidence direction. This is the case, for example, with algorithms which are used for directional microphone formation, for directional lobe alignment, for reconstruction of natural HRTFs from microphone signals, or for binaural interference noise suppression. The partial transfer function in these cases describes, as explained, the sound transmission from the sound source to a microphone.

In order to achieve an optimum effect of such algorithms, it is desirable to measure the partial transfer functions for every possible acoustic environment for matching of the electroacoustic appliance, for example, for matching a hearing aid. For a hearing aid, this means that the HRTF′s must be measured once again for each hearing aid user. Measurements such as these are generally very time-consuming and require expensive special equipment since, for example, the transfer functions must be measured for a large number of different incidence directions since they are dependent on the direction. The more accurately the HRTF′s are determined, the more accurately can, for example, a hearing aid be matched to a wearer. However, a sufficiently good result can be achieved just by a relatively good approximated HRTF′.

Alternatively, in the field of hearing aid technology, attempts have been made to take account of the effect of the head by a small number of parameters. By way of example, amplitude and phase adjustment is carried out for directional microphone systems for this purpose. For example, German Patent Document DE 199 27 278 C1 discloses a method for matching of a hearing aid, in which a hearing aid is ensonified in a suitable measurement room, and the directional characteristic is recorded, with the hearing aid being worn, by means of a number of microphones which are connected to one another in order to produce a directional characteristic. The filter parameters which result from this can be supplied to configurable filters connected downstream from the microphones. The desired ideal directional characteristic can be approximated in this way taking account of the individual acoustic characteristics when wearing the hearing aid.

An apparatus for matching of interaural level differences is known from U.S. Pat. No. 5,870,481. A number of hearing tests are carried out at different frequencies for this purpose, with the sound being produced by a sound source which can be moved relative to a test person. The hearing aid response for one ear is matched to that of the other ear by introducing attenuation or amplification, for example. The setting is made as a function of the localization capability of the test person.

One method for selection of the best HRTF from a predetermined set of HRTFs by means of a perceptive test is described in “Effiziente Auswahl der individuell-optimalen aus fremden Auβenohrübertragungsfunktionen”, [efficient selection of the individual-optimum outer ear transfer functions from external outer ear transfer functions]B. Seeber, H. Fastl, Deutsche Gesellschaft für Akustik DEGA eV, 2001, Oldenburg, ISBN 3-9804568-9-7. In this method, only a limited number of HRTFs are available in the set of HRTFs, so that, in some circumstances, it is not possible to find an individually suitable HRTF.

The practical importance of a subjective technique for refining a frequency amplification characteristic for a hearing aid with respect to a listener preference (Simplex method) is described in “An Examination of the Practicality of the Simplex Procedure”, J. E. Preminger et al., Ear & Hearing 2000, Lippincott Williams & Wilkins.

A model for description of HRTFs is described in “A model of head-related transfer functions based on principal component analysis and minimum-phase reconstruction.” D. Kistler, F. Wightmann, JASA (1992), Vol. 91, No. 3, p. 1637-1647. The model is based on a principal axes transformation (Principal Component Analysis PCA), which allows the HRTFs to be represented as a linear combination of a number of principal components.

### SUMMARY OF THE INVENTION

The invention is based on the object of providing a method for production of an approximated partial transfer function which is matched to an acoustic environment and which is faster and practically just as accurate as a time-consuming measurement of the partial transfer function.

According to the invention, this object is achieved by a method for production of an approximated partial transfer function, which can be used in an electroacoustic appliance for production of an environment correction transfer function, which matches an appliance transfer function for the electroacoustic appliance to an acoustic environment, where:

a number of basic functions, which each have one basic characteristic of a spectral profile of partial transfer functions, are provided,

the approximated partial transfer function is produced by combination of the basic functions weighted by weighting factors, in that the associated weighting factor is in each case determined for each basic function such that operation of the electroacoustic appliance is matched to an acoustic environment taking into account the approximated partial transfer function which is formed by the weighting factors and the basic functions, and

the approximated partial transfer function is stored in the electroacoustic appliance.

Various embodiments of the invention are summarized in the following discussion. The capability to represent the partial transfer function at least approximately with the aid of basic functions is of great importance to the method. This is possible, for example, by way of a principal axes transformation, which generally breaks down a transfer function into principal components which correspond to the basic functions.

One basic function in each case describes one basic characteristic of a spectral profile of the partial transfer function. In this case, where represented by way of basic functions, direction-dependent effects can be dealt with separately from direction-independent effects in the acoustic environment. Furthermore, it is possible to differentiate a partial transfer function in terms of magnitude and phase. Depending on the requirement, it is then possible, for example, to represent the magnitude of the partial transfer function by way of basic functions.

In a first basic function, for example, the general trend of the frequency dependency can be defined as a basic characteristic. Further basic functions make it possible to reproduce finer structures of the profile of the partial transfer function.

If the breakdown of the partial transfer function into basic functions is combined with continuous variation of weighting factors which are associated with the basic functions, the entire perceptively relevant search area is available for the production of the transfer function. The partial transfer function formed using the basic functions can be matched to the acoustic environment by variation of a small number of necessary weighting factors.

The expression production of the approximated partial transfer function in this case means that this partial transfer function is available at least in a configured form, that is to say that it can be calculated, for example, on the basis of the weighting factors in a relevant frequency range.

Previously ignored variables, such as direction-dependent effects or the directional dependency of the phase, can be included again in the production of the approximated partial transfer function.

The approximated partial transfer function may be stored and used in the electroacoustic appliance which, for example, may be a hearing aid, a system for production of virtual acoustics, or a multimedia system. The storage and use may be carried out by way of the weighting factors and basic functions, or in some other configuration. The latter is advantageous, for example, when the storage and use of the approximated partial transfer function are intended to be restricted to the spectral range processed by the respective appliance.

One advantage of the method according to an embodiment of the invention is that, by synthesis of the approximated partial transfer function by way of basic functions, it is possible to sample the entire perceptively relevant search area in a very quick manner in order to produce the partial transfer function, i.e., the entire perceptively relevant search area is available for production of the transfer function. D. Kistler and F. Wightman, in the article cited previously, have shown that, for example, a partial transfer function can be represented sufficiently well by five basic functions. In a corresponding manner, the search area could be scanned sufficiently finely and very quickly by adaptation of these five weighting factors.

The method can be applied to the determination of an entire set of approximated partial transfer functions for, for example, different incidence directions. In this case, the method can additionally be speeded up by taking account of relationships between the direction-dependent weighting factors and by optimizing only selected directions, and then interpolating further directions in a suitable form.

The method is “fast” in comparison to a measurement with direction-dependent, head-related transfer functions which are carried out, for example, in 5° steps in order to adjust microphones. A measurement such as this is time-consuming, since it must be carried out for each angle step, i.e., for each new position of a signal source. Furthermore, it must be carried out for each hearing air wearer.

In one particularly advantageous embodiment of the method, a weighting factor is determined for a partial transfer function relating to a head of a user such that a three-dimensional hearing impression is produced for that person with the aid of the electroacoustic appliance, taking into account the partial transfer function formed by the weighting factors and basic functions. In addition to the three-dimensional hearing impression, speech quality, tonal quality, localization performance and/or externalization of one or more signal sources can additionally or alternatively be assessed.

Externalization is defined as follows: when using headsets to produce acoustic signals, or when using hearing aids, the location at which the sound event is produced is frequently perceived as being located inside the head. If the sound source is localized outside the head in the same hearing situation, then this effect is referred to as externalization. This has the advantage that the subjective hearing impression is optimized, that is to say the influence from the acoustic environment on the subjective sensitivity is taken into account.

In one embodiment, the weighting factors are determined by way of an optimization method in which the optimum weighting factors are approached in steps by variation of at least one weighting factor. The optimization process may be carried out, for example, using the Simplex method, which finds the set of weighting factors for an optimum hearing impression, for example, by comparing pairs of “closest” neighbors.

In one advantageous embodiment, in order to determine the weighting factors, the electroacoustic appliance and the acoustic environment are simulated electronically by way of the partial transfer function as well as the appliance transfer function and, for example, are integrated in headset signals. This has the advantage that the transfer function can be determined independently of the presence of the electroacoustic appliance.

In one embodiment, the approximated partial transfer function is produced by interactive matching of the weighting factors to the acoustic environment which, in some circumstances, is also simulated. This is done by using statements from a user of the electroacoustic appliance relating to the hearing impression that is produced, for matching purposes.

In one embodiment, an initialization set of weighting factors is provided with an associated partial transfer function, with at least one further set of weighting factors being produced from the initialization set, in which at least one of the weighting factors has been changed, and with at least one further partial transfer function being produced from the amended set, and with two matching processes to an acoustic environment produced by these two different partial transfer functions being compared with one another.

In one development of the method, two or more partial transfer functions are produced and used, and are each matched to the acoustic environment for one incidence direction of an acoustic signal.

Further advantageous embodiments of the invention are described below.

### DESCRIPTION OF THE DRAWINGS

A number of exemplary embodiments of the invention are explained in the following text with reference to FIGS. 1 to 5.

FIG. 1 is a pictorial diagram showing the subject of direction-dependent transfer functions for hearing aids;

FIG. 2 is a block diagram illustrating various involved transfer functions for the use of an electroacoustic appliance;

FIG. 3 is a block schematic flowchart of an example of the procedure for the method according to an embodiment of the invention;

FIG. 4 is a pictorial diagram showing an example of how the method is carried out with the aid of computer-generated loudspeaker signals; and

FIG. 5 is a block diagram illustrating the production of the computer-generated loudspeaker signals shown in FIG. 4.

### DETAILED DESCRIPTION OF THE PREFERRED EMBODIMENTS

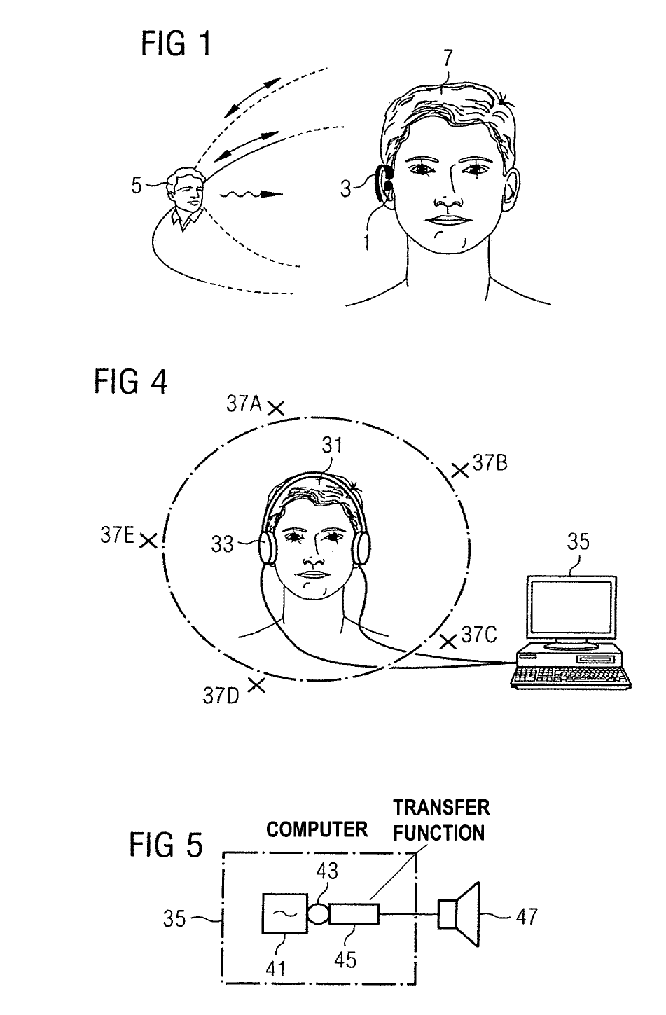

FIG. 1 illustrates the subject of direction-dependent transfer functions for hearing aids. A hearing aid such as this may, for example, be a hearing aid 1 which is worn in the ear, or a hearing aid 3 which is worn behind the ear. A sound source 5, for example, a conversation partner, produces sound waves which propagate to the wearer 7 of a hearing aid 1, 3. The sound wave is influenced by the external environment, in this case by the head of the wearer 7. The sound waves are detected by a microphone in one of the hearing aids 1, 3.

According to the convention used in the introduction to the description, the sound propagation from the sound source to the microphone can be associated with a partial transfer function, that is to say a modified transfer function. The influence of the acoustic environment depends on the position of the microphone and differs, for example, for the two hearing aids 1, 3. It also differs for hearing aids which are respectively arranged on the left ear and right ear of the wearer 7.

Furthermore, the partial transfer function depends on the direction in which the sound source 5 is located with respect to the microphone. The transfer function will also change in a corresponding manner when the sound source is moved horizontally or vertically around the head of the wearer 7. Accurate knowledge of the partial transfer function is important for hearing aids 1, 3, in order to produce a hearing impression which is as natural as possible for the wearer 7, in other words in order to reproduce the natural transfer function as well as possible. Furthermore, it is important to take account of partial transfer functions, for example, for use of localization algorithms.

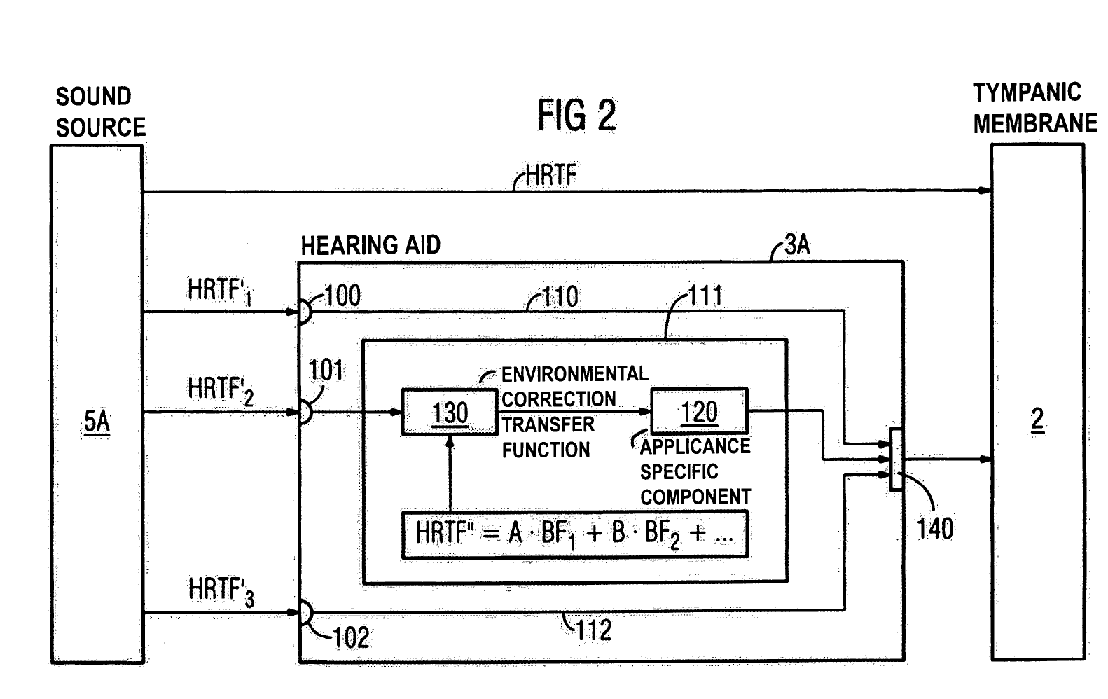

FIG. 2 shows the association, referred to initially, between the terms relating to the different involved transfer functions for sound transmission from a sound source 5A to a tympanic membrane 2. If no hearing aid is used, this results in a natural transfer function, that is HRTF, in this case, a head-related transfer function.

When using a hearing aid 3A which, for example, is worn behind the ear, the sound transmission is composed of:

partial transfer functions HRTF′₁, HRTF′₂, . . . from the sound source to in each case one of the microphones 100, 101, . . . , with the spectral coloring resulting from the auricula, for example, being ignored,

and from appliance transfer functions 110, 111, . . . .

The appliance transfer functions 110, 111, . . . include, inter alia, firstly an appliance-specific component 120, for example, which, inter alia, produces the correction for the hearing weakness, and a component which is intended to compensate for the difference between the natural transfer function and the partial transfer function, that is to say the effect of the acoustic environment. This component is referred to in the following text as the environment correction transfer function 130.

As mentioned above, one aim in the case of hearing aid technology as well as in the case of this invention is to improve the acceptance of a hearing aid by keeping the difference between the signal as heard and a signal that is transmitted with the natural transfer function HRTF as small as possible. As was likewise mentioned above, the environment correction transfer function 130 can be produced by way of the partial transfer function HRTF′, for example in a signal processing unit. One precondition in this case is knowledge of the partial transfer function HRTF′ᵢ, . . . or at least of an approximation of it, which is referred to in the following text as HRTF″₁. Since the measurement of a partial transfer function HRTF′ᵢ, . . . is time-consuming, the method according to the invention makes it possible to produce an approximated partial transfer function HRTF″₁ in a simple manner by linear combination of basic functions BFᵢ weighted with weighting factors A, B, . . . .

The signals from the microphones 100, . . . are passed in accordance with the appliance transfer functions 110, 111, . . . to the loud speaker 140, which produces sound that subsequently arrives at the tympanic membrane 2. The better the matching to the acoustic environment, the more natural the hearing aid sounds, and this is indicated, for example, by an improved capability for the user to locate noises.

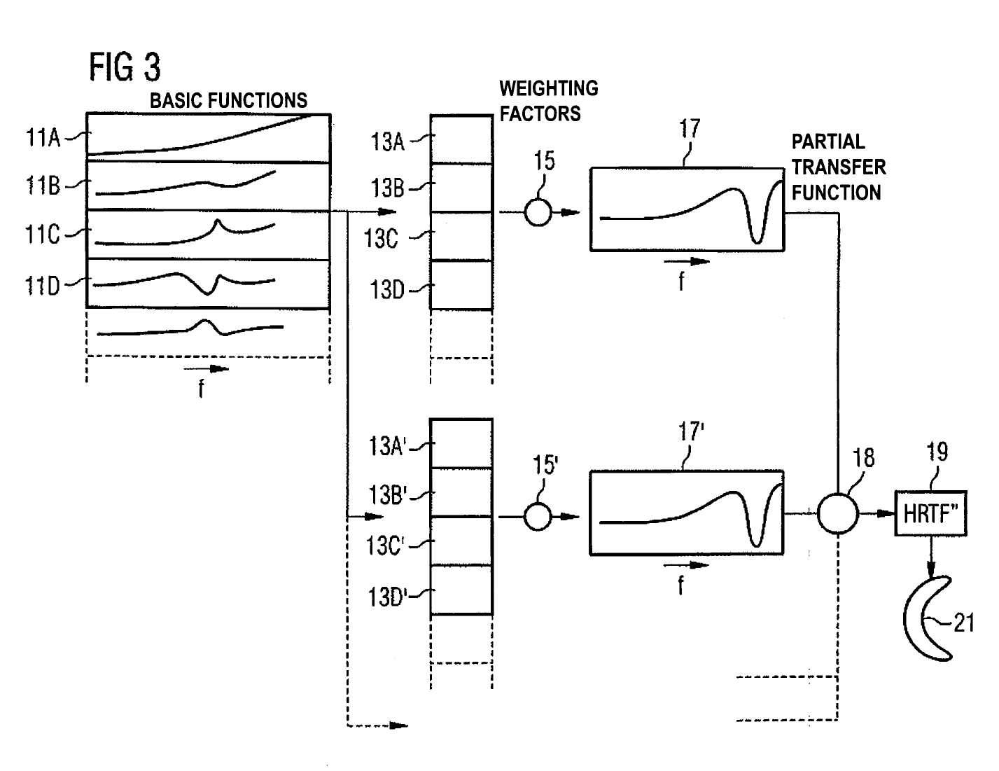

FIG. 3 shows one possible procedure for production of an approximated partial transfer function HRTF″ using an embodiment of the method according to the invention. The basic functions 11A-D were used for this production process. FIG. 3 shows, schematically, possible profiles of the magnitudes of the basic functions 11A-D as a function of the frequency f. The basic functions 11A-D are obtained once with the aid of a transformation from test partial transfer functions which are measured using a number of trials personnel.

The first basic function 11A is in this case produced, for example, by averaging all of the test partial transfer functions. The differences between all of the test partial transfer functions and the first basic function 11A are used to produce the second basic function 11B. The differences are once again averaged, thus resulting in the basic function 11B. The differences between the test partial transfer functions and the sum of all the basic functions determined prior to this are used, and are likewise averaged, in order to produce further basic functions 11C, 11D. A^{—}“back”-transformation process is used to produce any desired approximated partial transfer functions from these basic functions.

When producing the basic functions, partial transfer functions which have been averaged over a large number of individuals are, for example, transformed as far as possible such that they retain the perceptively relevant features.

The advantage of using weighting factors for production of the approximated partial transfer function is that the dimension of the area, that is to say the number of variables, is considerably smaller. One particularly suitable transformation process is a principle axes transformation (Principal Component Analysis PCA). This allows the HRTF′s/HRTF″s to be represented as a linear combination of, for example, five principal components.

Weighting factors 13A-D, 13A′-D′ are required for the “back”-transformation. For example, the transformation 15 is used to produce a first approximated partial transfer function 17, or the transformation 15′ is used to produce a second approximated partial transfer function 17′. That one of the approximated partial transfer functions 17, 17′, . . . , which produces the best match between operation of an electroacoustic appliance and the acoustic environment is determined by a comparison 18 of the effects of the approximated partial transfer functions 17, 17′ on, for example, the hearing impression.

Since the weighting factors 13A-D′ can be varied continuously, the entire perceptively relevant search area is scanned for the approximated partial transfer functions. The scanning process can be carried out using various optimization methods. In the so-called Simplex method, for example, pairs of approximated partial transfer functions which differ, for example, in only one weighting factor are compared in order to approach the optimum approximated partial transfer function. After each comparison of pairs, a further approximated partial transfer function in the vicinity of the better transfer function is produced by variation of at least one weighting factor 13A-D, and a comparison of pairs is once again carried out.

Once the optimum approximated partial transfer function 17, 17′ has been found, this is stored in a configured form 19 that is suitable for the electroacoustic appliance and is used in the electroacoustic appliance 21 during operation, for example by being included in the initially mentioned algorithms.

The process of optimizing the weighting factors is preferably based on a sensible initialization process, i.e., the weighting factors in the initialization set are produced, for example, by averaged weighting factors from partial transfer functions which are matched to the existing acoustic situation, for example to the use of a hearing aid in the ear.

The method according to embodiments of the invention has the advantage that the approximated partial transfer function is matched to, for example, the individual hearing aid wearer by way of a reasonable number of parameters. The production of the approximated partial transfer function is considerably faster than complex and time-wasting direct measurement of the transfer function by the hearing aid acoustic specialist.

A further advantage of the method is that the search area in which the approximated partial transfer function can be produced is considerably larger, since the PCA can be used to produce any transfer function.

FIG. 4 shows one possible configuration for determination of an approximated partial transfer function for a person 31. Acoustic signals 41 are played by way of a headset 33 to the person 31 who has to assess them interactively. The signals 41 are produced in a computer 35 (FIG. 5) and correspond to suitable acoustic situations which should be identified correctly by the person 31. For example, the signal corresponds to a point sound source which should be associated with the correct direction and distance, or corresponds to a concert, in which the position of the instruments involved should be reproduced correctly. By way of example, a number of acoustic signals are produced by different musical instruments for this purpose. The acoustic environment 43 is in this case also governed, for example, by positions 37A-E of the musical instruments.

When producing the approximated partial transfer function, the acoustic signal 41 is first of all produced in the computer 35, for example as shown in FIG. 5. The acoustic environment 43, that is to say, the associated partial transfer function of the acoustic situation, and an appliance transfer function 45 are then included in the signal 41. The approximated partial transfer function is used in one or more algorithms for signal processing therein. The signal simulated in this way corresponds to the signal from the sound source 5 from FIG. 1 taking into account the acoustic environment and the associated appliance transfer function.

The simulated signal is then supplied to a loud speaker 47. In this case, the partial transfer function that has been approximated with the aid of the basic functions can also be used for taking account of the acoustic environment 43 and the acoustic situation. The partial transfer functions for each of various musical instruments can be included in the acoustic signals by way of the computer 35.

The weighting factors are now likewise adapted with the aid of the computer 35 such that the person 31 perceives the acoustic environment correctly. This means that the approximated partial transfer function is optimized such that, for example, the person 31 perceives a three-dimensional hearing impression in such a way that he can correctly associate the various musical instruments with the predetermined acoustic environment (correctly adjusted localization and externalization of signal sources).

One or more approximated partial transfer functions obtained by such interactive matching are stored in the hearing aid and are read by the appropriate algorithms, and used for signal processing, during operation of the hearing aid.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detailed. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specially described as “essential” or “critical”. Numerous modifications and adaptations will be readily apparent to those skilled in this art without departing from the spirit and scope of the present invention.

What is claimed is:

1. A method for producing an approximated partial transfer function, which can be used in an electroacoustic appliance for production of an environment correction transfer function, which matches an appliance transfer function for the electroacoustic appliance to an acoustic environment, comprising:
providing a number of basic functions that each have one basic characteristic of a spectral profile of partial transfer functions;
producing the approximated partial transfer function by combining the basic functions weighted by weighting factors;
determining the weighting factor in each case for each basic function such that operation of the electroacoustic appliance is matched to an acoustic environment taking into account the approximated partial transfer function which is formed by the weighting factors and the basic functions; and
storing the approximated partial transfer function in the electroacoustic appliance for use during operation.

2. The method as claimed in claim 1, further comprising:
utilizing a main axes back-transformation for calculating the approximated partial transfer function.

3. The method as claimed in claim 1, further comprising:
providing the approximated partial transfer function utilizing the weighting factors as a linear combination of a number of basic functions.

4. The method as claimed in claim 1, wherein a basic function has a basic characteristic of a spectral profile of a magnitude of the partial transfer function.

5. The method as claimed in claim 1, further comprising:
utilizing a direction dependency of a phase of the partial transfer function when producing the partial transfer function.

6. The method as claimed in claim 1, further comprising:
utilizing characteristics related to a head of a person when producing the approximated partial transfer function.

7. The method as claimed in claim 6, further comprising:
determining one of the weighting factors such that a three-dimensional hearing impression is produced by the electroacoustic appliance for the person, taking into account the approximated partial transfer function which has been formed by the weighting factor and the associated basic function.

8. The method as claimed in claim 6, further comprising:
integrating, in an electronically simulated form to form headset signals in order to determine the weighting factors, at least one of: a) the appliance transfer function, b) the approximated partial transfer function resulting from the weighting factors, and c) the partial transfer function.

9. The method as claimed in claim 1, further comprising:
determining the weighting factors are determined using an optimization method in which the optimal weighting factors are approached in steps by variation of at least one weighting factor.

10. The method as claimed in claim 1, further comprising:
producing the approximated partial transfer function by interactive matching of the weighting factors to the acoustic environment of a person;
subjecting the person to acoustic test signals which are assessed by him; and
varying the weighting factors until the person perceives a hearing impression that primarily corresponds to the test signals.

11. The method as claimed in claim 10, further comprising:
utilizing statements of the person of the electroacoustic appliance relating to the hearing impression that is produced when performing interactive matching carried out by the varying of the weighting factors.

12. The method as claimed in claim 11, further comprising:
utilizing at least one of localization performance and externalization for assessing the hearing impression.

13. The method as claimed in claim 1, further comprising:
providing an initialization set of weighting factors, with an associated first approximated partial transfer function.

14. The method as claimed in claim 13, further comprising:
producing at least one amended set of weighting factors from the initialization set, varying at least one of the weighting factors,
forming at least one second approximated partial transfer function from the amended set; and
comparing, with one another, two processes of matching the electroacoustic appliance to an acoustic environment that are produced by way of two different approximated partial transfer functions.

15. The method as claimed in claim 1, further comprising:
producing a first basic function by averaging partial transfer functions measured in different acoustic environments.

16. The method as claimed in claim 15, further comprising:
producing a second basic function by averaging difference functions, with in each case one difference function being produced from one partial transfer function by subtracting the first basic function from it.

17. The method as claimed in claim 15, further comprising:
producing a further basic function by averaging difference functions that are each obtained from a difference between a partial transfer function and one or more basic functions.

18. The method as claimed in claim 1, further comprising:
producing two or more approximated partial transfer functions; and
matching each of the two or more approximated partial transfer functions to the acoustic environment for one incidence direction of an acoustic signal.
